(19) United States
(12) Patent Application Publication
(10) Pub. No.: US 2022/0176231 A1
(43) Pub. Date: Jun. 9, 2022

(54) Chess game with ranked pieces

(71) Applicant: Hamid Maadani, Agoura Hills, CA (US)

(72) Inventor: Hamid Maadani, Agoura Hills, CA (US)

(21) Appl. No.: 17/247,357

(22) Filed: Dec. 8, 2020

(51) Int. Cl. A63F 3/02; A63F 13/58; A63F 13/67

(52) U.S. Cl. CPC A63F 3/02; A63F 13/67; A63F 13/58

(57) ABSTRACT

A modified chess game for play by two or more opposing players. The game comprises of a conventional chess board, or any variation of that. Each player has a playing piece set, consisting of a king, a queen, two rooks, two knights, two bishops, and eight pawns, matching that of a conventional chess set, with the addition of a rank associated with each piece. The pieces are positioned as in conventional chess or any other variants, and they will be moved pursuant to conventional movements and rules of capture, except that upon a capture attempt, the outcome will be affected by the ranks of attacker and attacked pieces. A formula or instrument will be used to determine the chance of a successful capture attempt, and how it affect the ranks of each piece.

### BACKGROUND OF THE INVENTION

The present invention relates to chess games and, more specifically, to a new method of playing chess thereof affecting the piece presentation and attacking mechanism, along with its notation and a sample implementation.

### DESCRIPTION OF PRIOR ART

Conventional chess is a beautiful game of skill for two players, played upon an eight-by-eight square checkered board. Rules on how to move pieces, attack them, and win the game have been essentially untouched for hundreds of years, apart from some minor unifications more than a century ago, which resulted in the game universally played to this day.

Because of it's extended history, and the lure of chess as an almost infinite game, there has been many studies on game strategy, and intense analytics of the each stage of the game. Throughout the years, many proposals have been made to make modifications to the game. Some have aimed to change the physical appearance of the board (e.g. U.S. Pat. No. 4,804,191: Method of Playing Quad-radial Chess, or U.S. Pat. No. 5,112,056: Method of Playing a Three Dimensional Pyramidal Chess Game). Some, have tried to introduce new pieces to the game (e.g. U.S. Pat. No. 7,434,806: Chess variant and method of play thereof). Others, have tried to address the over-analyzation of the game, by randomizing opening piece placement on order to affect the opening strategies (e.g. FR-Chess, now called Chess960).

We conclude the description of prior art with the observation that we could not find any chess variant that has ever been invented up to now, which has added a ranking system to the pieces to demonstrate real world experience units gain in combat, or has modified the rules of attack and capture based on said ranking system.

### Purpose of the Invention

The present invention aims to address rules of piece attack/capture, and introduce a ranking mechanism into conventional chess or any other variant of the game. We believe new possibilities and strategies will arise from these modifications, where it comes to game strategy, developing new AI (Artificial Intelligence) models to accommodate new possibilities, and presentation of the game in both physical and electronic forms. This invention will:
1. NOT by itself make any modification to the board, although it can be incorporated into any modified form of the board.
2. Introduce a “reasonable” element of chance into the traditional chess game, in the hopes of creating new strategies and expanding the game possibilities.
3. Fully integrate and preserve the legacy of chess within the realms of the new game.

### SUMMARY AND OBJECTS OF THE INVENTION

The present invention will introduce ranking system to chess pieces, as well as modifications to rules of attack and piece capture. Each piece will attain experience and/or rank based on agreed upon rules. This rank, combined with a “reasonable” element of chance, will play a role in attacking another piece or defending against an attack.
One object of this invention, is to provide a chess game in which, pieces can accumulate rank, and benefit from their rank in case they are attacked by, or attack another piece;
A second object of this invention, is rank representation for each piece.
Another object of this invention, would be the mechanism to determine a successful attack.
A further object of this invention, is a moves per turn (MPT) limit on number of moves that can be performed in each turn, including piece capture attempts.
Still another object of this invention, would be an extension to Forsyth-Edwards and Portable Game Notations (FEN and PGN respectively), to include the ranking system for pieces in order to record the game and keep track of changes.

### BRIEF DESCRIPTION OF THE DRAWINGS

FIG. 1 is a sample rendering of described ranked chess pieces.

FIG. 2 shows a sample formula to use in order to calculate the chance of a successful capture attempt.

FIG. 3 is a sample of described R-FEN string, describing a position on the board.

FIG. 4 is a sample of described R-PGN text, showing the history of a game.

### DETAILED DESCRIPTION OF THE INVENTION

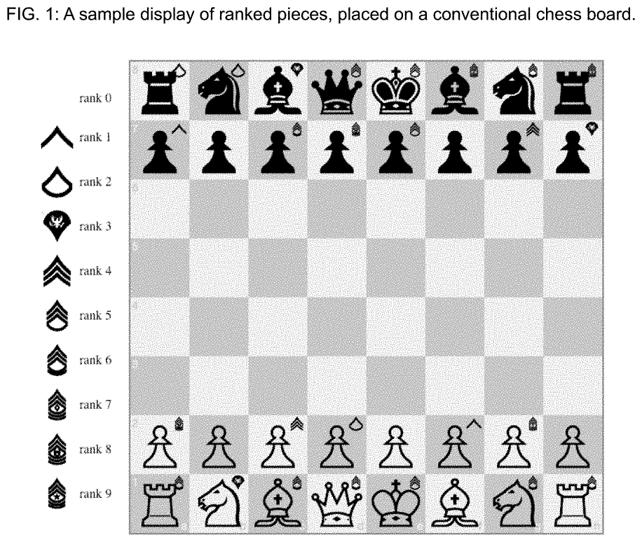

This modified chess game can be played by two or more opposing players. The game comprises of a conventional chess board, or any variation/modification of that. Each player has a playing piece set, consisting of a king, a queen, two rooks, two knights, two bishops, and eight pawns, matching that of a conventional chess set with the addition of a rank associated with each piece. The rank can be random, agreed upon, or carried over from previous games based on agreed upon rules and formulas. One representation of ranked pieces can be seen in FIG. 1, however, the rank can be displayed in any chosen manner.

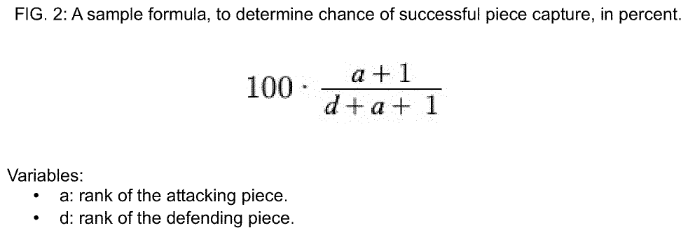

The pieces are positioned as in conventional chess or any other variants (e.g. chess960, 3D chess, etc.), and they will be moved pursuant to conventional movements and rules of capture, except that upon a capture attempt, the outcome will be affected by the ranks of attacker and attacked pieces. A formula and/or instrument (e.g. any form of dice) will be used to determine the chance of a successful capture. As a sample implementation, the inventor proposes to use the formula shown in FIG. 2 to determine the chance of a successful capture attempt, as a percent represented value.

If successful, the attacked piece will be reduced in rank (ideally to rank 0), and removed from the board, and the turn will be over. If unsuccessful, neither piece is moved. The attacked and/or attacker pieces' ranks may or may not be affected, based on the agreed upon rules and formulas. For the purpose of a sample implementation, we will leave the ranks unchanged after a failed capture attempt. The player initiating the attack, will regain their move for the turn, granted they have not gone over the agreed upon move limit per turn (e.g. 3 moves per turn maximum).

When it comes to promoting a pawn, this invention follows the rules of the conventional chess, with the addition of a rank reduction for the new piece. A suggested formula would be to decrease the rank of the promoted piece, by half the conventional worth of the promoted piece, rounded to the nearest number. For example, if a pawn with a rank of 7, is promoted to a knight (worth 3 points), the new knight will have the rank of 5. However, if it is promoted to a queen (worth 9 points), the new queen will have a rank of 2. The more powerful the promoted piece, more of a rank reduction is suggested.

The same move can not be made twice in the same turn. For example, if a rank 5 pawn tries to capture a rank 3 knight and fails, the same pawn will not be permitted to attack the same knight in the same turn. Each turn will have a limited number of moves (e.g. 3 MPT), and will be over once a piece has moved to another square, or has attacked and successfully captured another piece, or if the moves per turn limit is reached.

A king's rank will have absolutely no effect on a check or checkmate situation. A king shall not be able to evade check or checkmate, using it's rank alone. In case of a position where the king has to take the piece which has put it in check in order to come out of check (i.e. opposite color queen in an immediate square to the king), the chance of the king taking the opposite piece must be 100% and no less.

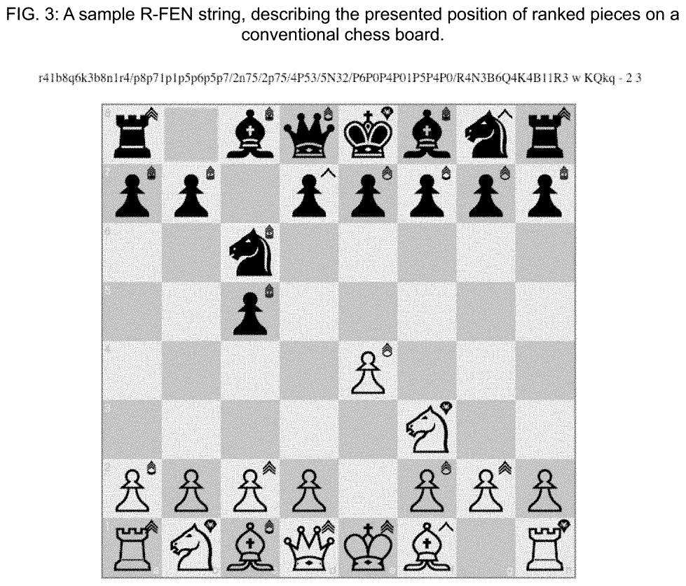

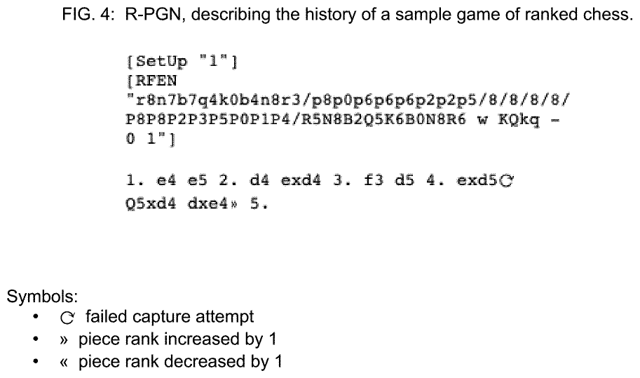

In order to provide an instrument to describe the board, an extension to FEN notation is proposed, where each piece has to be followed by it's rank as a number. For example, in conventional FEN, row 8 of the conventional board will be displayed as “rnbqkbnr”. The same row, comprised of now ranked pieces, will be displayed as “r6n8b1q2k7b5n4r0” in ranked FEN (R-FEN). Piece color and empty square notations would be untouched, where lowercase letters show black pieces, uppercase letters show white pieces, and any number between 1 and 8 not immediately preceded by a valid piece letter, would represent empty squares. A Fully formed R-FEN can be seen in FIG. 3. We also propose the same extension to be made for the PGN format, in order to reflect piece ranking in game history, with the addition of following symbols: [symbol] to identify a failed capture attempt, » to identify a rank increase and « for rank decrease. A sample ranked PGN (R-PGN) can be seen in FIG. 4.

The winner of the game will be determined by conventional chess rules.

1. A method of playing chess (conventional or any derivative form) in any physical or electronic form, comprising of the steps below:
a) Providing each player with visibly distinguishable sets of ranked chess pieces, positioned according to conventional chess positioning rules or any derivative of them.
b) Moving the playing pieces according to conventional chess rules, or any derivative of those rules, according to the following restrictions:
Upon attacking a piece of the opposite side, the outcome will be affected by the ranks of the attacker and the attacked pieces. A formula and/or instrument will be used to determine the chance of a successful capture. If successful, the attacked piece will be reduced in rank and removed from the board, and the turn will be over. If unsuccessful, neither piece is moved. The attacked and/or attacker pieces' ranks may or may not be affected, based on the agreed upon rules and formulas. The player initiating the attack, will regain their move for the turn, granted they have not gone over the agreed upon move limit per turn.
c) The same move can not be made twice in the same turn.
d) Pawn promotion would infer a rank reduction.
e) The winner will be determined by conventional chess rules.
